(19) United States
(12) Patent Application Publication
(10) Pub. No.: US 2023/0337757 A1
(43) Pub. Date: Oct. 26, 2023

(54) HEATING CONTROL FOR HEATED GEAR

(71) Applicant: MILWAUKEE ELECTRIC TOOL CORPORATION, Brookfield, WI (US)

(72) Inventors: Jonathan S. Pinske, Pewaukee, WI (US); Bradley Van Wagoner, Germantown, WI (US)

(21) Appl. No.: 18/304,082

(22) Filed: Apr. 20, 2023

Related U.S. Application Data
(60) Provisional application No. 63/333,705, filed on Apr. 22, 2022.

(51) Int. Cl. A41D 13/005; G05D 23/24; H05B 1/02

(52) U.S. Cl. CPC A41D 13/0051; G05D 23/24; H05B 1/0272; H05B 2203/036

(57) ABSTRACT

A heated garment including a garment body, a heater coupled to the garment body, and a controller for controlling the heater including an electronic processor. The controller is configured to receive an input signal indicating a first heater mode, determine a requested heater temperature level based on the first heater mode, determine a temperature, determine, based on the temperature, that the heater is able to maintain the requested heater temperature level for a first period of time, set a heater temperature level to the requested heater temperature level for the first period of time, and set the heater temperature level to a second temperature for a second period of time after the first period of time has elapsed.

### RELATED APPLICATIONS

This application claims the benefit of U.S. Provisional Patent Application No. 63/333,705, filed Apr. 22, 2022, the entire content of which is hereby incorporated by reference.

### FIELD

The present disclosure relates to heated garments and, in particular, controlling the temperature of heating elements in heated garments.

### SUMMARY

Heated garments include heating elements to produce heat that warms a wearer of the heated garment. For example, heating elements may include heater arrays that use carbon fiber heaters, conductive ink fabrics, and/or thermoelectric heating/cooling devices, among other things. Heating elements may be controlled to provide multiple heater temperature levels based on a heater mode (e.g., high, medium-high, medium, medium-low, low) that is input by a user. Traditionally, inefficient heating controls have led to decreased temperature levels over time. For example, a heater temperature level corresponding to a high heater mode may have been selected by a user, and the heater may have tried to hold onto the heater temperature level that corresponds to the high heater mode for as long as possible. However, the power that powers the heaters may come from a battery pack and, thus, may subsequently diminish quickly while trying to maintain the high heater temperature level. Accordingly, there is a need for an improved heating control for heaters that will provide a high level of warmth to a wearer for a greater amount of time as compared to the traditional control described above.

The present disclosure provides, among other things, heater control for heating elements of heated gear that increases runtimes at set heater modes. For example, a heater control may include a controller that receives an input by a user. The input corresponds to a heater mode, and the heater control may provide a requested heater temperature level for a first predetermined amount of time. The heater control may then drop the heater temperature level to a lower heater temperature level for a second predetermined amount of time. The heater control cycles between the requested heater temperature level and the lower heater temperature level for the predetermined amounts of time to maintain a feeling corresponding to the heater mode input by the user. The feeling of the requested heater temperature level is able to be maintained due to the time it takes for the heater to “cool” to the lower heater temperature level. During a “cooling time,” the heater is between the requested heater temperature level and the lower heater temperature level, thus providing a feeling that is very similar to the requested heater temperature level as the heat cycles between the two temperature levels. However, because of the lower heater temperature level for the second predetermined time, the operational runtime for the heated gear from one battery pack is increased.

Embodiments described herein provide a heated garment. The heated garment including a garment body, a heater coupled to the garment body, and a controller for controlling the heater including an electronic processor. The controller is configured to receive an input signal indicating a first heater mode, determine a requested heater temperature level based on the first heater mode, determine a temperature, determine, based on the temperature, that the heater is able to maintain the requested heater temperature level for a first period of time, set a heater temperature level to the requested heater temperature level for the first period of time, and set the heater temperature level to a second temperature for a second period of time after the first period of time has elapsed.

Embodiment described herein provide a method for controlling a heater of a heated garment. The method includes receiving, with an electronic processor of the heated garment, an input signal including a selected first heater mode, determining, with the electronic processor, a requested heater temperature based on the selected first heater mode, determining, with the electronic processor, a temperature associated with the heated garment, determining, with the electronic processor, based on the temperature associated with the heated garment, that the heater is able to maintain the requested heater temperature for a first period of time, setting, with the electronic processor, a heater temperature level to the requested heater temperature for the first period of time, and setting, with the electronic processor, the heater temperature level to a second temperature for a second period of time after the first period of time has elapsed.

Embodiments described herein provide a heated garment. The heated garment including a garment body, a heater coupled to the garment body, and a controller for controlling the heater including an electronic processor. The controller is configured to receive an input signal indicating a first heater mode, determine a requested heater temperature level based on the first heater mode, determine a temperature, determine, based on the temperature, that the heater is unable to maintain the requested heater temperature level for a first period of time, set a heater temperature level to a second temperature level for the first period of time, and set the heater temperature level to a third temperature for a second period of time after the first period of time has elapsed.

Before any embodiments are explained in detail, it is to be understood that the embodiments are not limited in their application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

### BRIEF DESCRIPTION OF THE DRAWINGS

FIG. 1A illustrates a front view of a heated garment, according to some embodiments.

FIG. 1B illustrates a back view of the heated garment of FIG. 1A, according to some embodiments.

FIG. 2 illustrates a battery pack used to power to heaters of the heated garment of FIGS. 1A and 1B, according to some embodiments.

FIG. 3 illustrates a schematic of a controller for the heated garments of FIGS. 1A and 1B, according to some embodiments.

FIG. 4A illustrates a graph of a heater control for a low heater mode, according to some embodiments.

FIG. 4B illustrates a graph of a heater control for a medium heater mode, according to some embodiments.

FIG. 4C illustrates a graph of a heater control for a high heater mode, according to some embodiments.

FIG. 5 is a flowchart illustrating a method of controlling the heaters of the heated garment of FIGS. 1A and 1B, according to some embodiments.

### DETAILED DESCRIPTION

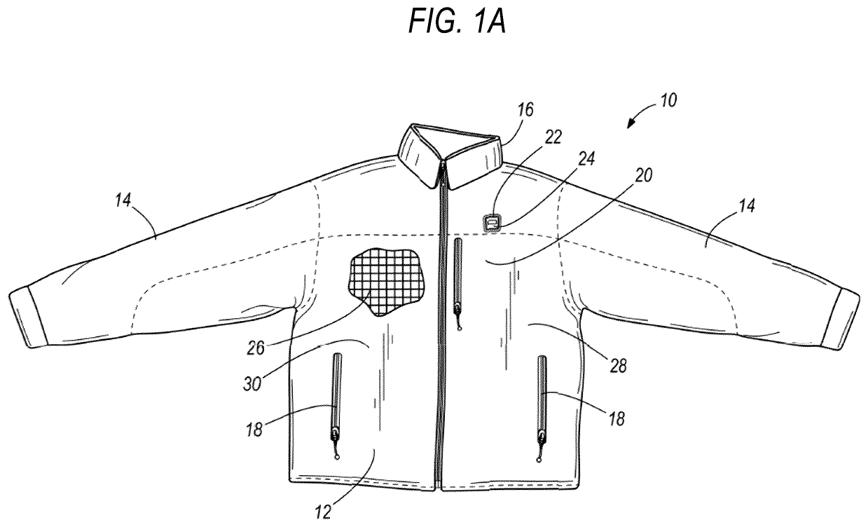

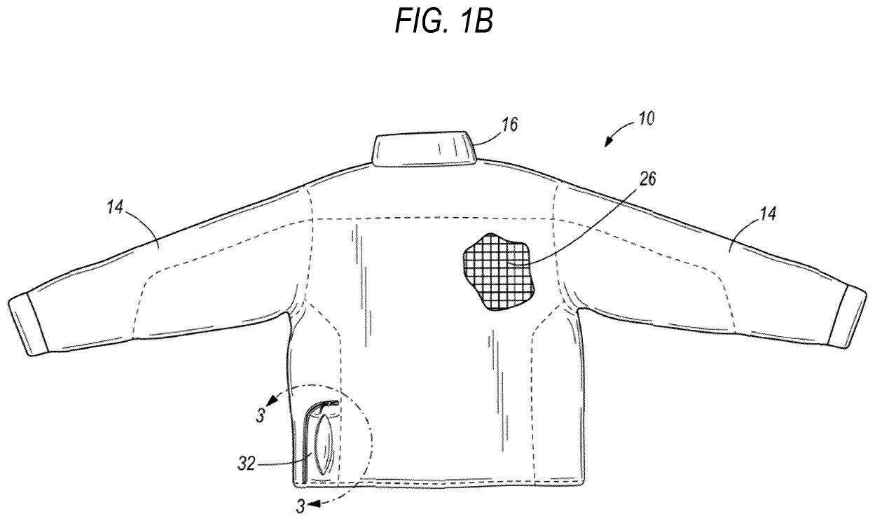

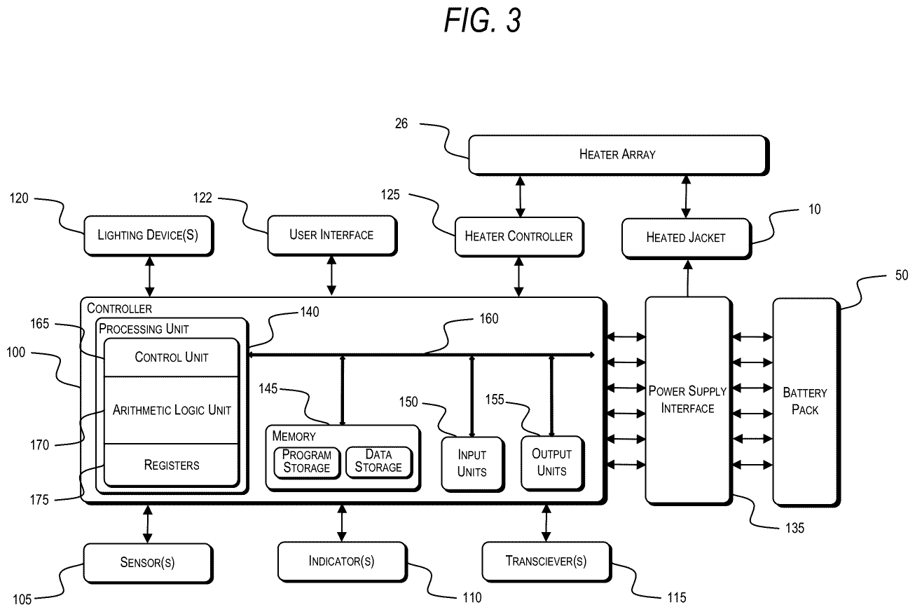

FIG. 1A illustrates a heated garment 10, according to some embodiments. The illustrated heated garment 10 is a heated jacket, however, other garments such as shirts, vests, pants, leggings, overalls, gloves, hats, and shoes or boots may be contemplated. The heated garment 10 may be constructed in various sizes to fit a variety of users. The heated garment 10 includes typical jacket features such as a torso body 12, arms 14, a collar 16, front pockets 18, and a user interface 22 located on a chest area 20. As illustrated in cutaway portions of FIGS. 1A and 1B, the heated garment 10 includes a heater array 26. The heater array 26 is disposed in both a left portion 28 and a right portion 30 of the torso body 12. In some embodiments, the heater array 26 may extend into the arms 14 and/or collar 16. The heater array 26 may be configured to generate heat based on a received DC voltage from a battery pack, for example battery pack 50 (FIG. 3). For example, the heater array 26 may be a resistive heater array, a carbon fiber heater, and/or a conductive ink heater. However, other heater array types are also contemplated. In other embodiments, the heated garment 10 may include a first heater array and second heater array arranged as an upper module and a lower module, respectively. In some embodiments, the heater array 26 is controlled based on input from an external device. In some embodiments, multiple heater arrays may be controlled individually via a single control input or multiple control inputs. For example, the multiple heater arrays may be isolated and controlled based on input from the external device. The heater array 26 may also include resistive heating coils formed of carbon fibers, high density carbon fibers, or other heating devices. The heated garment 10 is capable of maintaining a temperature of up to 110 degrees Fahrenheit, although in other embodiments, lower or greater temperatures are possible depending upon the heat source.

In some embodiments, the heater array 26 may include a negative temperature coefficient (NTC) thermistor or a positive temperature coefficient (PTC) thermistor to determine temperature. For example, the NTC or PTC thermistor would be added to the heater array 26 to determine the heater temperature or another temperature associate with the heated garment 10. In some embodiments, where a carbon fiber heater is implemented in the heated garment 10, an NTC or PTC thermistor may also be included. The NTC or PTC thermistor may be added to the heater on or close to the carbon fiber element and the garment ambient surroundings. In some embodiments where a conductive ink heater is implemented in a heated garment, the current required to provide heat to the heater array may be determined by a current sensor. For example, a PTC heater may be used such that the current automatically reduces as the temperature of the heater increases based on feedback received from the current sensor.

The user interface 22 may include an indicator 24 to indicate a heater mode to a user. For example, a user may be able to apply pressure to (e.g., “click”) the user interface 22 a certain number of successive times to indicate a heater mode and a requested heater temperature. The indicator 24 may change colors corresponding to the heater mode that was input by the user via the user interface 22. Heater modes and heater control based on the requested heater temperature will be described below.

As illustrated in cutout 3-3 of FIG. 1B, the heated garment 10 includes a compartment 32 located on a lower portion of the back torso body. The compartment 32 houses an electrical component, such as a battery pack 50, and battery holder that holds the battery pack 50. The heated garment 10 includes a connection port for connecting to the battery pack 50.

In some embodiments, the heated garment 10 may include a controller, such as controller 100 (FIG. 3). In some embodiments, the heated garment 10 may include at least one connection port for connecting to other heated garments. For example, the connection port(s) may be a USB, USB-C, or USB-PD port. The connection port(s) may be located on the torso body 12, arms 14, and/or collar 16 of the heated garment 10. Garments connected to the heated garment 10 via the connection port may receive input power from the battery pack 50.

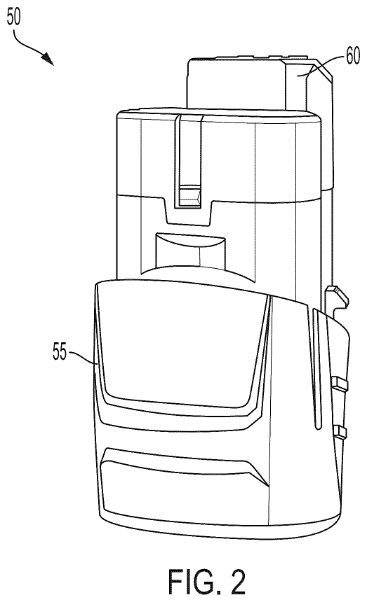

FIG. 2 illustrates a battery pack 50 to be used with the heated garment 10. The battery pack 50 includes a housing 55 and an interface portion 60 for connecting the battery pack 50 to a device (e.g., the heated garment 10). In some embodiments, the battery pack 50 includes lithium ion battery cells. In other embodiments, the battery pack 50 may be of a different chemistry, for example, nickel-cadmium, nickel-metal hydride, and the like. In the illustrated embodiment, the battery pack 50 is a 12 volt battery pack. In other embodiments, the output voltage level of the battery pack 50 may be different. For example, the battery pack 50 can be a 4 volt battery pack, 28 volt battery pack, 40 volt battery pack, or another voltage. The battery pack 50 may also have various capacities (e.g., 1.5, 2, 3, 4, 5, 6, 8, or 12 ampere-hours).

The battery pack 50 also includes terminals to connect to the heated garment 10. The terminals for the battery pack 50 includes a positive terminal and a negative terminal to provide power to and from the battery pack 50. In some embodiments, the battery pack 50 also includes data terminals to communicate with the heated garment 10. For example, the battery pack 50 may include a microcontroller to monitor one or more characteristics of the battery pack 50, and the data terminals may communicate with the heated garment 10 regarding the monitored characteristics.

FIG. 3 illustrates a controller 100 for a heated garment (e.g., heated garment 10). The controller 100 is electrically and/or communicatively connected to a variety of modules or components of the heated garment 10. For example, the illustrated controller 100 is connected to sensors 105 (which may include, for example, current sensors, voltage sensors, temperature sensor, etc.), indicators 110, a transceiver(s) 115, lighting device(s) 120, a heater controller 125, and the battery pack 50. In some embodiments, the controller 100 may be included in the battery pack 50 such that the battery pack 50 controls the heated garment 10.

The controller 100 includes a plurality of electrical and electronic components that provide power, operational control, and protection to the components and modules within the controller 100 and/or heated garment 10. For example, the controller 100 includes, among other things, a processing unit 140 (e.g., a microprocessor, an electronic processor, an electronic controller, a microcontroller, or another suitable programmable device), a memory 145, input units 150, and output units 155. The processing unit 140 includes, among other things, a control unit 165, an arithmetic logic unit (“ALU”) 170, and a plurality of registers 175 (shown as a group of registers in FIG. 3), and is implemented using one or more computer architectures (e.g., a modified Harvard architecture, a von Neumann architecture, etc.). The processing unit 140, the memory 145, the input units 150, and the output units 155, as well as the various modules connected to the controller 100 are connected by one or more control and/or data buses (e.g., common bus 160). The control and/or data buses are shown generally in FIG. 3 for illustrative purposes. The use of one or more control and/or data buses for the interconnection between and communication among the various modules and components would be known to a person skilled in the art in view of the embodiments described herein.

The memory 145 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 140 is connected to the memory 145 and executes software instruction that are capable of being stored in a RAM of the memory 145 (e.g., during execution), a ROM of the memory 145 (e.g., on a generally permanent basis), or another non-transitory computer readable medium such as another memory or a disc. Software included in the implementation of the battery pack 50 can be stored in the memory 145 of the controller 100. The software includes, for example, firmware, one or more applications, program data, filters, rules, one or more program modules, and other executable instructions. The controller 100 (e.g., the processing unit 140) is configured to retrieve from the memory 145 and execute, among other things, instructions related to the control processes and methods described herein. In other embodiments, the controller 100 includes additional, fewer, or different components.

The indicators 110 receive control signals from the controller 100 to turn ON and OFF, or otherwise convey information based on different heater modes, different states of the battery pack 50, connectivity between the heated garment 10 and an external device, etc. For example, the indicators 110 may display that the heater array 26 is ON, that the heater array is set to a requested heater mode (e.g., high, medium-high, medium, medium-low, or low), that the battery pack 50 is depleted, that the controller 100 is communicatively connected to an external device (e.g., a mobile device), etc. The indicators 110 include, for example, one or more light-emitting diodes (LEDs), or a display screen (e.g., an LCD). The display/indicator(s) 110 may also include additional elements to convey information to a user through audible or tactile outputs (e.g., a speaker). The display/indicator(s) 110 may also be referred to as an output device configured to provide an output to a user.

The transceiver(s) 115 may include a Bluetooth® controller that communicates with a Bluetooth® enabled device, such as the external device. The transceiver(s)115 may transmit information regarding components of the heated garment 10, a status of the heater array 26, information about the heated garment 10, and/or a status of the battery pack 50. For example, the transceiver(s) 115 may transmit information such as the requested heater temperature of the heated garment 10, the current heater temperature level of the heated garment 10, timer information regarding the time left at a current heater temperature level, a type of heated garment coupled to the heated garment 10, heating zones, and/or preset information to the device by communicating with a Bluetooth® controller of the device. The transceiver(s)115 may receive control signals from the external device. For example, the control signals may include temperature set points, heating zones to activate/deactivate, and heater array runtime. In some embodiments, the transceiver(s) 115 communicates with the external device employing the Bluetooth® protocol. Therefore, in some embodiments, the external device and the heated garment 10 are within a communication range (i.e., in proximity) of each other while they exchange information.

In some embodiments, controller 100 may receive user input via a user interface 122. The user interface 122 may be coupled to the heated garment 10, such as user interface 22 on heated garment 10 (FIG. 1). The user interface 122 may physically receive an input from a user that transmits information and control signals to the controller 100. For example, the input may be the a heater mode and a requested heater temperature of the heated garment 10.

A power supply interface 135 is connected to the controller 100 and couples to the heated garment (e.g., heated garment 10). The power supply interface 135 includes a combination of mechanical (e.g., an interface portion) and electrical components configured to and operable for interfacing (e.g., mechanically, electrically, and communicatively connecting) the battery pack 50 with the heated garment 10. The power supply interface 135 transmits the power from the battery pack 50 to the heated garment 10. The power supply interface 135 includes active and/or passive components (e.g., voltage step-down controllers, voltage converters, rectifiers, filters, etc.) to regulate or control the power transmitted to the heated garment 10.

The heater controller 125 may dynamically adjust the heating level of the heated garment 10. For example, based on an input received from the external device via the transceiver(s) 115 and/or the user interface 122 (e.g., a heater mode of the heated garment 10) the heater controller 125 may adjust the heating level of the heater array 26 to be able to operate the heater array in the requested heater mode.

The heater controller 125 may dynamically adjust the heating level of the heated garment 10 based on a plurality of heater modes (e.g., high, medium-high, medium, medium-low, and low). Each heating mode corresponds to a requested temperature level. For example, the high heater mode corresponds to 50° C.+0° C./−4° C., the medium-high heater mode corresponds to 41° C.±2° C., the medium heater mode corresponds to 36° C.±2° C., the medium-low heater mode corresponds to 33° C.±2° C., and the low heater mode corresponds to 30° C.±2° C.

In some embodiments, the controller 100 may receive input from negative temperature coefficient (NTC) thermistors. A first NTC thermistor may communicate the current temperature of the heater array 26. A second NTC thermistor may communicate the ambient temperature around the heated garment 10. Alternatively, or additionally, the controller 100 may receive an input from a current sensor. For example, the current of the heater array 26 may decrease as the temperature of the heater increases. Based on the sensed current and, thus, the sensed temperature, the temperature of the heaters may be determined.

Traditionally, a heater array has been energized at a set temperature for as long as possible based on the charge of a battery pack providing power to the heater array. However, this causes a decrease in temperature as a battery voltage of the battery decreases. Another traditional way of operating a heater array has included receiving an input from a NTC thermistor and maintaining a set temperature as long as possible. Both of these traditional methods do not provide a wearer of a heated garment 10 a sustained, desired warmth for a desired period of time.

The heater controller 125 may operate the heater array 26 in a dynamic manner to provide a desired warmth to a wearer of the heated garment 10 for an increased period of time. For example, based on the input (e.g., a heater mode) by the user either via the user interface 122 or an external device, the heater controller 125 may control the heater array 26 to provide a first temperature for a first period of time and then drop or reduce the temperature to a second temperature for a second period of time. The heater controller 125 may then alternately cycle between the two temperatures for the two periods of time. The first period of time can be less than the second period of time. The first period of time may be in the range of 30 seconds to two minutes, and the second period of time may be in the range of four minutes to 20 minutes. For example, when a low heater mode is requested, the heater controller 125 may provide a first temperature for one minute and a second temperature for 15 minutes. The controller 100 may receive an input from multiple NTC thermistors at multiple zones throughout the heated garment 10. Based on the temperature of the heater array 26 at a particular zone in the heated garment 10, the heater controller 125 may provide different currents to the heater array 26 at the particular zone to maintain the first temperature. In some embodiments, when the NTC thermistor coupled to the heater array 26 is not working properly, the heater controller 125 may cycle between the first temperature and the second temperature based on a detected temperature of ambient surroundings, as sensed by an ambient temperature NTC thermistor.

In some embodiments, the first temperature corresponds to the requested temperature level in a desired heater mode (e.g., the high heater mode corresponding to 50° C.+0° C./−4° C., the medium-high heater mode corresponding to 41° C.+2° C., the medium heater mode corresponding to 36° C.±2° C., the medium-low heater mode corresponding to 33° C.±2° C., and the low heater mode corresponding to 30° C.±2° C.). The second temperature may be between 10-20° C. less than the first temperature. In some embodiments, the second temperature may be 15° C.±2° C. less than the first temperature for the heater modes. Alternatively, or additionally, in some embodiments, the second temperature may be 10° C.±2° C. less than the first temperature when the first temperature level cannot be maintained at the requested temperature level (e.g., the voltage of the battery pack 50 is low, the ambient temperature is below a threshold value, etc.).

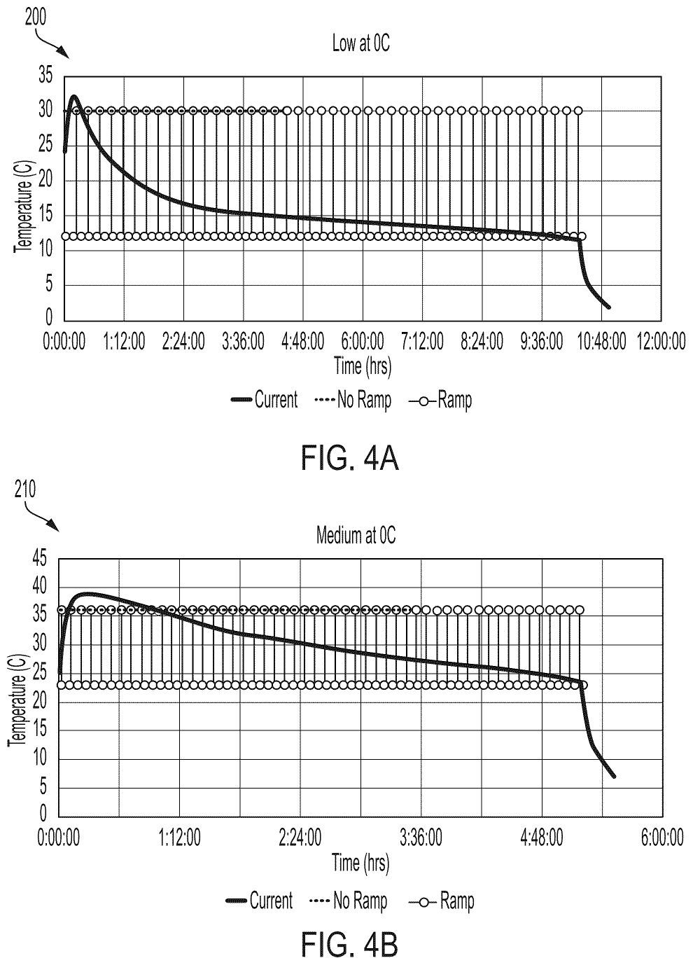

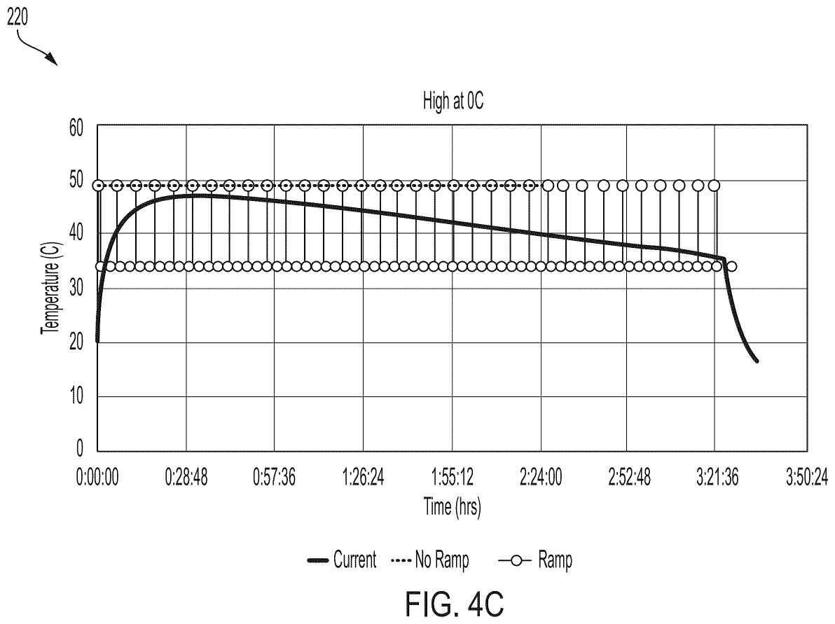

FIGS. 4A-4C include graphs 200, 210, 220, respectively, illustrating the heater control during different heating modes. The graph 200 of FIG. 4A illustrates a low heater mode. In the low heater mode, the heater controller 125 varies the temperature of the heater array according to a duty cycle of a pulse-width modulation (PWM) signal. Based on a user requesting a low heater mode, the heater controller 125 controls the heater array 26 to provide a first heat level for a first period of time and a second heat level for a second period of time. The first heat level corresponds to a first temperature (e.g., 30° C.) that the heater array 26 is set to, as sensed by an NTC thermistor. The second heat level corresponds to a second temperature (e.g., 12° C.) that the heater array 26 is set to, as sensed by the NTC thermistor. The first period of time may be one minute and the second period of time may be five minutes. The heater controller 125 may constantly cycle between the first temperature for the first period of time and the second temperature for the second period of time. In some embodiments, the first period of time is less than the second period of time.

The graph 210 of FIG. 4B illustrates a medium heater mode. In the medium heater mode, the heater controller 125 varies the temperature of the heater array according to a duty cycle of a pulse-width modulation (PWM) signal. Based on a user requesting a medium heater mode, the heater controller 125 controls the heater array 26 to provide a first heat level for a first period of time and a second heat level for a second period of time. The first heat level corresponds to a first temperature (e.g., 36° C.) that the heater array 26 is set to, as sensed by an NTC thermistor. The second heat level corresponds to a second temperature (e.g., 24° C.) that the heater array 26 is set to, as sensed by the NTC thermistor. The first period of time may be one minute and the second period of time may be five minutes. The heater controller 125 may constantly cycle between the first temperature for the first period of time and the second temperature for the second period of time. In some embodiments, the first period of time is less than the second period of time.

The graph 220 of FIG. 4C illustrates a high heater mode. In the high heater mode, the heater controller 125 varies the temperature of the heater array according to a duty cycle of a pulse-width modulation (PWM) signal. Based on a user requesting a high heater mode, the heater controller 125 controls the heater array 26 to provide a first heat level for a first period of time and a second heat level for a second period of time. The first heat level corresponds to a first temperature (e.g., 50° C.) that the heater array 26 is set to, as sensed by an NTC thermistor. The second heat level corresponds to a second temperature (e.g., 35° C.) that the heater array 26 is set to, as sensed by the NTC thermistor. The first period of time may be one minute and the second period of time may be five minutes. The heater controller 125 may constantly cycle between the first temperature for the first period of time and the second temperature for the second period of time. In some embodiments, the first period of time is less than the second period of time.

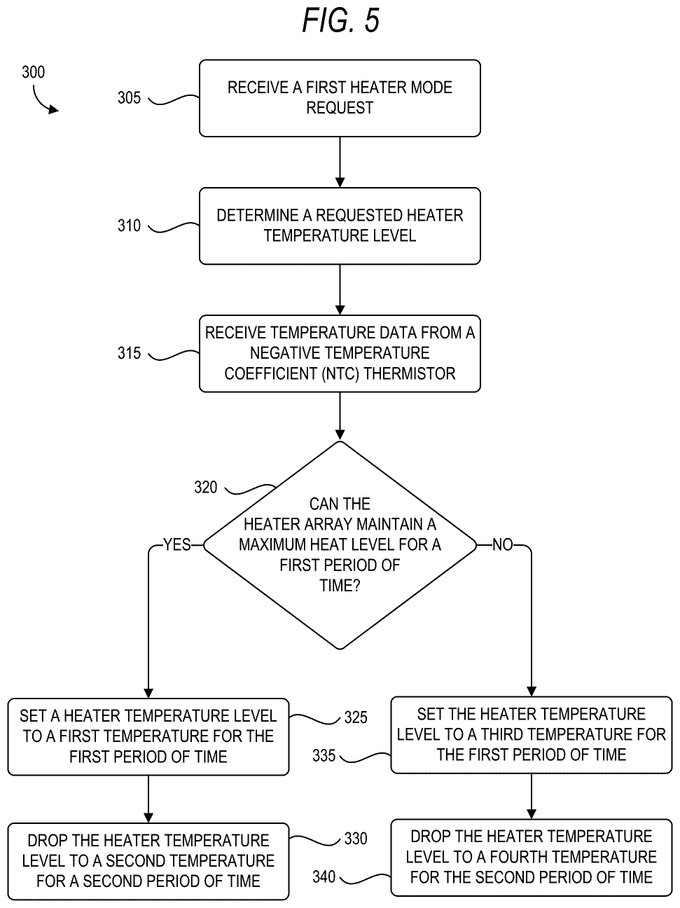

FIG. 5 is a method 300 for controlling the heater array 26 of the heated garment 10, according to embodiments described herein. In step 305, the controller 100 receives a first heater mode request. The heater mode request may come from the user interface 122 or the external device. For example, a user may interact with a user interface of the external device to select a heater mode. The heater mode may be, for example, one of a high, medium-high, medium, medium-low, and low heater mode. In step 310, the controller 100 determines a requested heater temperature level. The requested heater temperature level corresponds to the selected heater mode. For example, when a high heater mode is selected, the requested heater temperature level is determined to be 50° C.+0° C./−4° C.

In step 315, the controller 100 receives temperature data from a negative temperature coefficient (NTC) thermistor. In some embodiments, the NTC thermistor is coupled to the heater array 26 of the heated garment 10. Alternatively, or additionally, in some embodiments, the NTC thermistor detects an ambient temperature of the environment around the heated garment 10. In some embodiments, the controller 100 receives temperature data from multiple NTC thermistors coupled to the heater array 26 at various parts throughout the heated garment 10.

In decision step 320, the controller 100 determines whether the heater array 26 can maintain a maximum heat level for a first period of time (e.g., corresponding to the selected heater mode). In some embodiments, the controller 100 determines whether the heater array 26 can maintain a maximum heat level based on a voltage level of the battery pack 50 and/or the ambient temperature. The first period of time may be, for example, any time in the range of 30 seconds to five minutes. When the controller 100 determines that the heater array 26 can maintain the maximum heat level for the first period of time, the method 300 proceeds to step 325. When the controller 100 determines that the heater array 26 cannot maintain the maximum heat level for the first period of time, the method 300 proceeds to step 335.

In step 325, the heater controller 125 sets a heater temperature level to a first temperature for the first period of time. For example, the heater controller 125 sets the heater temperature level of the heater array 26 to 50° C. for one minute. The heater controller 125 may control the heater temperature level by controlling a current provided from the battery pack 50 to the heater array 26. In step 330, the heater controller 125 drops or reduces the heater temperature level to a second temperature for a second period of time. For example, the heater controller 125 sets the heater temperature level of the heater array 26 to 35° C. for five minutes. The heater controller 125 may set the second temperature to a temperature around 15° C. (e.g., about 30%) less than the first temperature when the heater array 26 is able to maintain the maximum heat level for the first period of time. The heater controller 125 may decrease the amount of current provided to the heater array 26 to decrease the temperature. The temperature values specifically recited above are intended only to be exemplary, and any of a variety of temperature values can be selected for first heater temperature level and the second heater temperature level.

In step 335, the heater controller 125 sets the heater temperature level to a third temperature for the first period of time. For example, the heater controller 125 sets the heater temperature level of the heater array 26 to 40° C. for one minute. In some embodiments, 40° C. is determined to be the maximum temperature that the heater array 26 can maintain for one minute. In step 340, the heater controller 125 sets the heater temperature level to a fourth temperature for the second period of time. For example, the heater controller 125 sets the heater temperature level of the heater array 26 to 30° C. for five minutes. The heater controller 125 may set the fourth temperature to a temperature around 10° C. (e.g., about 25% less) less than the third temperature when the heater array 26 is unable to maintain the maximum heat level for the first period of time. The temperature values specifically recited above are intended only to be exemplary, and any of a variety of temperature values can be selected for third heater temperature level and the fourth heater temperature level.

The controller 100 may continuously determine whether the heater array 26 can maintain a maximum heat for the first period of time. The method 300 would then proceed from step 320.

Thus, embodiments described herein provide, among other things, systems and methods of controlling a heater of a heated garment. Various features and advantages are set forth in the following claims.

What is claimed is:

1. A heated garment comprising:
a garment body;
a heater coupled to the garment body; and
a controller for controlling the heater including an electronic processor, wherein the controller is configured to:
receive an input signal indicating a first heater mode,
determine a requested heater temperature based on the first heater mode,
determine a temperature associated with the heated garment,
determine, based on the temperature, that the heater is able to maintain the requested heater temperature for a first period of time,
set a heater temperature level to the requested heater temperature for the first period of time, and
set the heater temperature level to a second temperature for a second period of time after the first period of time has elapsed.

2. The heated garment of claim 1, wherein the second temperature is less than the requested heater temperature.

3. The heated garment of claim 1, wherein the controller is further configured to:
set the heater temperature level to the requested heater temperature for the first period of time in response to the heater temperature level being at the second temperature for the second period of time.

4. The heated garment of claim 3, wherein the controller is further configured to:
continuously cycle the heater temperature level between the requested heater temperature for the first period of time and the second temperature for the second period of time.

5. The heated garment of claim 1, wherein the controller is further configured to:
determine, based on the temperature, that the heater is unable to maintain the requested heater temperature level for the first period of time;
set the heater temperature level to a third temperature for the first period of time; and
reduce the heater temperature level to a fourth temperature for the second period of time after the first period of time at the third temperature has elapsed.

6. The heated garment of claim 1, wherein the temperature is one of a temperature of the heater and an ambient temperature around the heated garment.

7. The heated garment of claim 1, wherein the input signal is received from a user interface coupled to the heated garment.

8. The heated garment of claim 1, wherein the first period of time is less than the second period of time.

9. The heated garment of claim 1, wherein the controller is further configured to:
set at least one of the requested heater temperature for the first period of time and the second temperature for the second period of time by controlling a duty cycle of a pulse width modulation (PWM) signal provided to the heater.

10. A method for controlling a heater of a heated garment, the method comprising:
receiving, with an electronic processor of the heated garment, an input signal including a selected first heater mode,
determining, with the electronic processor, a requested heater temperature based on the selected first heater mode,
determining, with the electronic processor, a temperature associated with the heated garment,
determining, with the electronic processor, based on the temperature associated with the heated garment, that the heater is able to maintain the requested heater temperature for a first period of time,
setting, with the electronic processor, a heater temperature level to the requested heater temperature for the first period of time, and
setting, with the electronic processor, the heater temperature level to a second temperature for a second period of time after the first period of time has elapsed.

11. The method of claim 10, wherein the second temperature is less than the requested heater temperature.

12. The method of claim 10, wherein the first period of time is less than the second period of time.

13. The method of claim 10, wherein the input signal is received from one of a user interface of an external device.

14. The method of claim 10, wherein the temperature associated with the heated garment is one of the heater temperature or an ambient temperature external to the heated garment.

15. A heated garment comprising:
a garment body;
a heater coupled to the garment body; and
a controller for controlling the heater, the controller including an electronic processor, the controller configured to:
receive an input signal indicating a first heater mode,
determine a requested heater temperature based on the first heater mode,
determine a temperature associated with the heated garment,
determine, based on the temperature, that the heater is unable to maintain the requested heater temperature for a first period of time,
set a heater temperature level to a second temperature for the first period of time, and
set the heater temperature level to a third temperature for a second period of time after the first period of time has elapsed.

16. The heated garment of claim 15, wherein:
the second temperature is less than the requested heater temperature; and
the third temperature is less than the second temperature.

17. The heated garment of claim 15, wherein the temperature is determined using a negative temperature coefficient (NTC) thermistor.

18. The heated garment of claim 15, wherein the controller is configured to set at least one of the second temperature for the first period of time and the third temperature for the second period of time by controlling a duty cycle of a pulse width modulation (PWM) signal provided to the heater.

19. The heated garment of claim 15, wherein the input signal is received from a user interface coupled to the heated garment.

20. The heated garment of claim 15, wherein the first period of time is less than the second period of time.
